(19) United States
(12) Patent Application Publication
(10) Pub. No.: US 2010/0232672 A1
(43) Pub. Date: Sep. 16, 2010

(54) PROJECTION-BASED REMOVAL OF HIGH-CONTRAST OBJECTS

(75) Inventors: Uwe Jandt, Hamburg (DE); Dirk Schaefer, Hamburg (DE); Michael Grass, Buchholz in der (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/673,508

(22) PCT Filed: Aug. 12, 2008
(86) PCT No.: PCT/IB08/53229

§ 371 Date: Feb. 15, 2010

(30) Foreign Application Priority Data
Aug. 17, 2007 (EP) 07114531.2

(51) Int. Cl. G06K 9/00; G06K 9/40

(52) U.S. Cl. 382/132; 382/264

(57) ABSTRACT

A system (900) and method for automatic projection-based removing of high-contrast artificial objects from a medical image is provided. The method comprises performing a low-pass filtering (1100) to the two-dimensional image (100, 500, 1000) using a filter width range (1110) corresponding to structures of a line-shaped artificial object to generate a low-pass filtered intensity image and performing an evaluation of the Hessian matrix of each pixels of the low-pass filtered intensity image for locating and enhancing the structure of the line-shaped artificial object to generate a multi-scale filtered intensity image, wherein predefined scaling widths are used in order to avoid the locating and enhancing of larger structures.

The invention relates to the field of imaging. In particular, the invention relates to a method for removal of intervention objects in fluoroscopy imaging, a relating imaging system, a program element and a computer readable medium.

Reconstruction image quality of volume data generated e.g. from rotational X-ray projection sequences is in many cases affected by overlaying high-contrast objects, such as catheters, stitches etc. This is especially crucial for examinations of the left atrium and of coronary veins, where a large number of interventional objects is—at least partially—in the field of view. The high-contrast objects do not move necessarily synchronously to the heart motion, thus they cause motion artifacts in subsequent data processing, e.g. strong streaks in gated or non-gated reconstruction.

In image-guided procedures high-contrast objects often appear in the imaging field-of-view for the purpose of guiding treatment (e.g., markers intended to localize the target) or delivering treatment (e.g., surgical tools, or in the case of brachytherapy, radioactive seeds). In cone-beam CT reconstructions, these high-contrast objects cause severe streak artifacts, CT number inaccuracy and loss of soft-tissue visibility. Moseley, D. J. et al (Medical Imaging 2005: Physics of Medical Imaging. Edited by Flynn, Michael J. Proceedings of the SPIE, Volume 5745, pp. 40-50 (2005)) have developed an iterative approach by which high-contrast objects are localized in a 2-D projection set by re-projecting conspicuities from a first-pass 3-D reconstruction. A projection operator, which finds the unique mapping from a world coordinate system to a detector coordinate system for each view angle, is computed from a geometric calibration of the system. In each projection, a two-dimensional 2^{nd} order Taylor series is used to interpolate over the high-contrast objects. The interpolated surface is further modified using a local noise estimate to completely mask the objects. The algorithm has been applied to remove artifacts resulting from a small number of gold fiducial markers in patients being imaged daily with cone-beam CT for guidance of prostate radiotherapy. The algorithm has also been applied to post-operative images of a prostate brachytherapy patient in which the number of seeds can exceed ˜100. In each case, the method provides an attenuation of image artifact and restoration of soft-tissue visibility.

There may be a need for an alternative image analysis technique, which can automatically remove unwanted artificial objects as stents, catheters from an image, precisely a projection image.

In an exemplarily embodiment a method for removing high-contrast structures of line-shaped artificial objects with small width on a two-dimensional image is proposed. The method comprising the steps:

performing a low-pass filtering to each pixel of the two-dimensional image in an intensity range of a structures of a line-shaped artificial object to generate a low-pass filtered intensity image, and

performing a multi-scale filter to the low-pass filtered intensity image for locating and enhancing the structure of the line-shaped artificial objects to generate a multi-scale filtered intensity image, wherein a predefined scaling width is used in order to avoid the locating and enhancing of larger structures.

The proposed method may enables for automated removal of high-contrast objects as e.g. contrast agent directly on the projections.

In another embodiment the method comprises of the following steps:
1. filtering of the projections based on a multi-scale vessel enhancement filter approach, according to an disclosure of Frangi et al. in A. F. Frangi, W. J. Niessen, K. L. Vincken, M. A. Viergever, “Multiscale vessel enhancement filtering”, Medical Image Computing & Computer Assisted Interventions, MICCAI98, vol. 1496 of Lecture Notes in Computer Science, pp. 130-7, 1998, which is incorporated herein herewith by reference.
2. segmenting the enhanced structures with a fixed or adaptive threshold value
3. expanding the segmented areas by morphological erosion,
4. extrapolating pixels within the segmented and expanded areas by distance weighted brightness values derived from surrounding pixels.

It should be noted that preferably very small scales (1-2 pixels) are incorporated in order to avoid detection of larger structures like coronaries or the atrium. Thus, small-scaled structures, e.g. catheters, stitches, wires etc. are enhanced.

According to another aspect, the method comprises performing a low-pass filtering to the two-dimensional image using a filter width range corresponding to structures of a line-shaped artificial object to generate a low-pass filtered intensity image and performing an evaluation of the Hessian matrix of each pixels of the low-pass filtered intensity image for locating and enhancing the structure of the line-shaped artificial object to generate a multi-scale filtered intensity image, wherein predefined scaling widths are used in order to avoid the locating and enhancing of larger structures.

The proposed method may helps to reduce or eliminate high-contrast objects on the acquired projections. Streak artifacts in reconstructions are reduced or eliminated and modeling quality is improved. The accuracy of the segmentation process can be improved using adaptive thresholds.

According to an aspect of one embodiment, the method further comprising: segmenting of enhanced structures located by the applied multi-scale filter with a threshold value.

According to an aspect of one embodiment, the threshold value is fixed or predefined.

According to an other aspect of one embodiment, the threshold value is adaptive.

According to an other aspect of one embodiment, the method further comprising: expanding the enhanced segmenting structures by an erosion process. E.g. the erosion may takes place with three pixel around the segmented areas.

According to yet an other aspect of one embodiment, the method further comprising: extrapolating the segmented and expanded areas by distance weighted gray-level values derived from surrounding pixel of the two-dimensional image. Thus, the gray-scale values of the segmented and expanded areas are adapted to the gray-scale values of the surrounding pixel taking interpolation and distance weighting into account.

Preferably, the gray-scale contribution of a surrounding pixel is reciprocal to the linear distance to the pixel of the segmented or expanded area in question.

According to an other aspect of one embodiment, the predefined scaling width is σ, with σₘᵢₙ≦σ≦σₘₐₓ, wherein σₘᵢₙ may have a size of one pixel and σₘₐₓ may have a size of two pixels.

According to a further aspect of one embodiment, the algorithm of the multi-scale filter uses a Hessian matrix which is defined as

$$H ( σ , {p}_{x} , {p}_{y} ) = ( \begin{matrix}\frac{{\partial }^{2} {I}^{′} ( σ , {p}_{x} , {p}_{y} )}{\partial {p}_{x} \partial {p}_{x}} & \frac{{\partial }^{2} {I}^{′} ( σ , {p}_{x} , {p}_{y} )}{\partial {p}_{x} \partial {p}_{y}} \\ \frac{{\partial }^{2} {I}^{′} ( σ , {p}_{x} , {p}_{y} )}{\partial {p}_{y} \partial {p}_{x}} & \frac{{\partial }^{2} {I}^{′} ( σ , {p}_{x} , {p}_{y} )}{\partial {p}_{y} \partial {p}_{y}}\end{matrix} ) ,$$

wherein I′(σ, pₓ, p_{y}) is the intensity value of a pixel of a low-pass filtered intensity projection I′ at an image position with pixel coordinates pₓ and p_{y} and with a predefined scale size σ. Analysing the Hessian matrix has an intuitive justification in the context of detection of the artificial tubular object which is projected line-shaped.

The multi-scale filter, e.g. a multi-scale vessel enhancement filter, may be based on the analysis of eigenvalues of the Hessian matrix. The eigenvalues are applied to the low-pass filtered projections, or. Gauss-filtered projections, with different scale sizes or Kernel sizes σ. Preferably, two scale sizes e.g. of one pixel and two pixel are used.

According to yet an other aspect of one embodiment, the algorithm of the multi-scale filter is based on an analysis of eigenvalues λ₁ and λ₂ of the Hessian matrix H(σ, pₓ, p_{y}), the eigenvalues λ₁ and λ₂ are defined as

$${λ}_{\frac{1}{2}} ( σ , {p}_{x} , {p}_{y} ) = \frac{{I}_{xx} + {I}_{yy}}{2} \pm \sqrt{\frac{{( {I}_{xx} + {I}_{yy} )}^{2}}{4} + ( {I}_{xy} {I}_{yx} - {I}_{xx} {I}_{yy} )}$$

with

$${I}_{ij} = \frac{{\partial }^{2} {I}^{′} ( σ , {p}_{i} , {p}_{j} )}{\partial {p}_{i} \partial {p}_{j}} .$$

The idea behind eigenvalue analysis of the Hessian matrix is to extract the principle direction in which a local structure of the image can be decomposed.

According to a further aspect of one embodiment, the method further comprising:

defining for each pixel position pₓ and p_{y} a multi-scale filtered projection value R^{2D} with: R^{2D}(pₓ,p_{y})=max(σ^{3/2}λ₁(σ, pₓ, p_{y})|σₘᵢₙ≦σ≦σₘₐₓ), and applying the acquired multi-scale filtered projection value R^{2D} to the two-dimensional image.

According to a further aspect, the two-dimensional image is a projection image generated from rotational X-ray projection sequences.

According to a further aspect, the line-shaped artificial objects is configured as one of the group consisting of a catheter, a wire guide tip, a stitch or a surgical tool.

According to a further embodiment, a system for automated projection based removal of artificial high-contrast objects from a medical image, comprising:

a memory device for storing a program;

a processor in communication with the memory device, the processor operative with the program to:

performing a low-pass filtering to each pixel of the two-dimensional image in an intensity range of a structures of a line-shaped artificial object to generate a low-pass filtered intensity image;

performing a multi-scale filter to the low-pass filtered intensity image for locating and enhancing the structure of the line-shaped artificial object to generate a multi-scale filtered intensity image; wherein a predefined scaling width is used in order to avoid the locating and enhancing of larger structures.

According to a further embodiment, a computer program product comprising a computer useable medium having a computer program logic recorded thereon for removing artificial high-contrast objects from a medical image, the computer program logic comprising:

program code for performing a low-pass filtering to each pixel of the two-dimensional image in an intensity range of a structures of a line-shaped artificial object to generate a low-pass filtered intensity image;

program code for performing a multi-scale filter to the low-pass filtered intensity image for locating and enhancing the structure of the line-shaped artificial object to generate a multi-scale filtered intensity image; wherein predefined scaling widths are used in order to avoid the locating and enhancing of larger structures.

These and other aspects of the present invention may become apparent from and elucidated with reference to the embodiments described hereinafter.

Exemplary embodiments of the present invention will be described in the following, with reference to the following drawings.

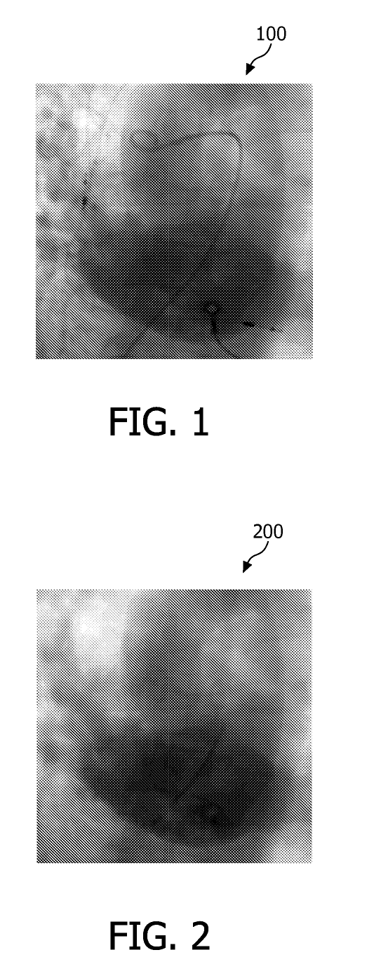

FIG. 1 shows a gray scale X-ray projection image of a patient with visible contrast agent in the left atrium.

FIG. 2 shows the same projection as shown in FIG. 2 but with small-scaled high-contrast objects, like the contrast agent inflow catheter, removed or widely suppressed according to the invention.

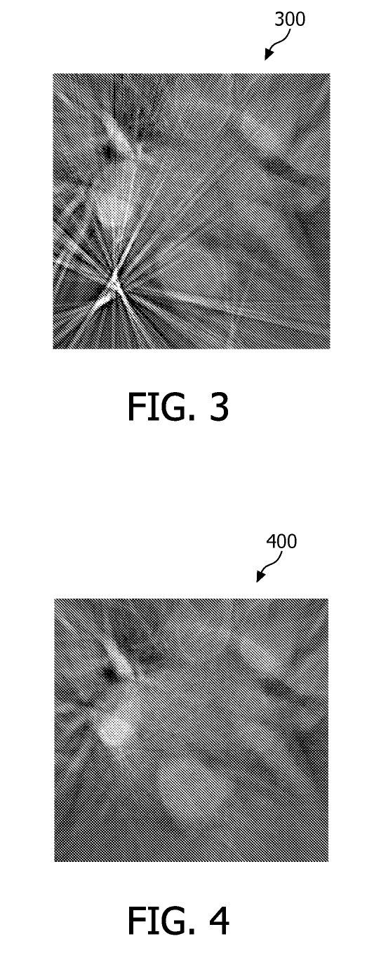

FIG. 3 shows an axial slice of an image reconstruction from unfiltered projections.

FIG. 4 shows the same reconstruction as shown in FIG. 3 but with small-scaled high-contrast objects as the contrast agent removed from the projections according to the invention.

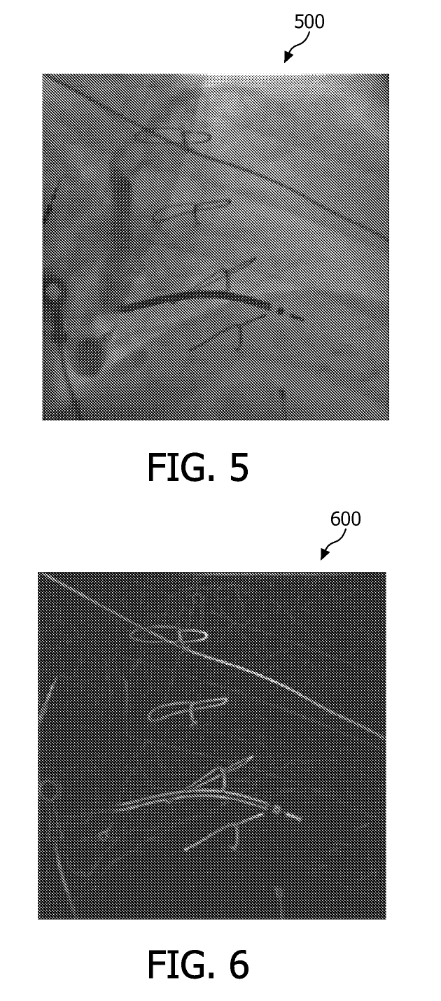

FIG. 5 shows a two-dimensional X-ray image with several high-contrast artefacts.

FIG. 6 shows the image of FIG. 5 after low-pass and multi-scale filtering.

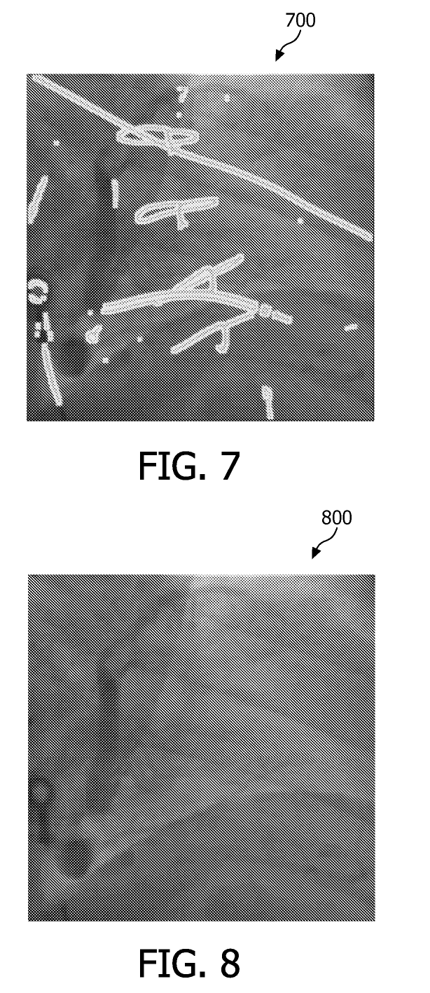

FIG. 7 shows the image of FIG. 6 after segmentation and erosion of the said high-contrast objects.

FIG. 8 shows the image of FIG. 7 after an interpolation process and

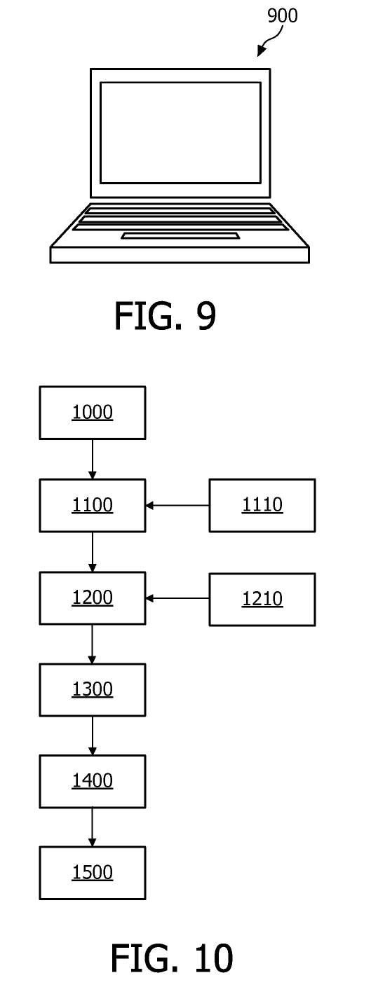

FIG. 9 shows a system for automated projection based removal of artificial high-contrast objects from a medical image according to the invention.

FIG. 10 shows a flow chart of an embodiment of the proposed method.

The illustration in the drawings is schematically. In different drawings, similar or identical elements are provided with the same reference numerals.

FIG. 1 shows a gray scale X-ray projection image 100 of a patient with visible contrast agent in the left atrium and FIG. 2 shows an image 200 which is the same projection as shown in FIG. 2 but with small-scaled high-contrast objects, like the contrast agent inflow catheter, removed or widely suppressed according to the invention.

FIG. 3 shows an axial slice 300 of an image reconstruction from unfiltered projections and FIG. 4 shows an axial slice 400 which corresponds to the reconstruction as shown in FIG. 3 but with small-scaled high-contrast objects removed from the projections according to the invention.

FIG. 5 shows a two-dimensional X-ray image 500 with several high-contrast artefacts before filtering.

After applying a method, which is shown as a flow chart in FIG. 10, for removing the several high-contrast structures of line-shaped artificial objects with small width from the shown image 500, generally after performing a low-pass filtering 1100 to each pixel of an two-dimensional image 1000 in an intensity range of a structures of a line-shaped artificial object a low-pass filtered intensity image not shown here is generated. A multi-scale filter 1200 is applied to the low-pass filtered intensity image for locating and enhancing the structure of the line-shaped artificial object, a multi-scale filtered intensity image 600 as shown in FIG. 6 is generated wherein predefined scaling widths are used during the filter process in order to avoid the locating and enhancing of larger structures.

The low-pass filtering 1100 using a filter width range 1110 with a predefined scale size σ corresponding to structures of a line-shaped artificial object to generate a low-pass filtered intensity image as shown in FIG. 6.

Thus, FIG. 6 shows the image 600 corresponding to image 500 of FIG. 5 after low-pass and multiscale filtering. Precisely, an algorithm of the multi-scale filter which uses a Hessian matrix was applied to the pixel of image 5. The Hessian matrix was defined as

$$H ( σ , {p}_{x} , {p}_{y} ) = ( \begin{matrix}\frac{{\partial }^{2} {I}^{′} ( σ , {p}_{x} , {p}_{y} )}{\partial {p}_{x} \partial {p}_{x}} & \frac{{\partial }^{2} {I}^{′} ( σ , {p}_{x} , {p}_{y} )}{\partial {p}_{x} \partial {p}_{y}} \\ \frac{{\partial }^{2} {I}^{′} ( σ , {p}_{x} , {p}_{y} )}{\partial {p}_{y} \partial {p}_{x}} & \frac{{\partial }^{2} {I}^{′} ( σ , {p}_{x} , {p}_{y} )}{\partial {p}_{y} \partial {p}_{y}}\end{matrix} ) ,$$

wherein I′(σ, pₓ, p_{y}) is the intensity value of a pixel of a low-pass filtered intensity projection I′ at an image position with pixel coordinates pₓ and p_{y} and with a predefined scale size σ.

The algorithm of the multi-scale filter used here, was based on an analysis of eigenvalues λ₁ and λ₂ of the Hessian matrix H(σ, pₓ, p_{y}), the eigenvalues λ₁ and λ₂ are defined as

$${λ}_{\frac{1}{2}} ( σ , {p}_{x} , {p}_{y} ) = \frac{{I}_{xx} + {I}_{yy}}{2} \pm \sqrt{\frac{{( {I}_{xx} + {I}_{yy} )}^{2}}{4} + ( {I}_{xy} {I}_{yx} - {I}_{xx} {I}_{yy} )}$$

$$with$$

$${I}_{ij} = \frac{{\partial }^{2} {I}^{′} ( σ , {p}_{i} , {p}_{j} )}{\partial {p}_{i} \partial {p}_{j}} .$$

In a further step, a multi-scale filtered projection value R^{2D} with:

R^{2D}(pₓ, p_{y})=max(σ^{3/2}λ₁(σ, pₓ, p_{y})|σₘᵢₙ≦σ≦σₘₐₓ), was defined for each pixel position pₓ and p_{y}, in other words, the said maximum value was determined. Further, the acquired multi-scale filtered projection value R^{2D} was applied to the two-dimensional image.

FIG. 7 shows an image 700 based on the image data of the image 600 (FIG. 6) after segmentation and erosion of the said high-contrast objects. The segmenting of enhanced structures located by the applied multi-scale filter was done with a fixed threshold value.

FIG. 8 shows an image 800 based on the image data of the image 700 after an interpolation process (FIG. 10, step 1400).

FIG. 9 shows a system 900 for automated projection based removal of artificial high-contrast objects from a medical image according to the invention which is adapted to perform the claimed method.

FIG. 10 shows a flow chart according to one embodiment of the claimed method. The method enables to remove high-contrast structures of line-shaped artificial objects with small width on a two-dimensional image 1000.

In step 1100 the method performs a low-pass filtering to each pixel of the two-dimensional image in an intensity range of a structure of a line-shaped artificial object to generate a low-pass filtered intensity image. The low-pass filter uses a filter width range 1110 corresponding to structures of a line-shaped artificial object. In step 1200

a multi-scale filter is performed to the low-pass filtered intensity data for locating and enhancing the structure of the line-shaped artificial object to generate a multi-scale filtered intensity image; wherein predefined scaling widths 1210, which have preferably the same range as it is used in step 1110 are used in order to avoid the locating and enhancing of larger structures.

In step 1300 enhanced structures located by the applied multi-scale filter are segmented with a predefined threshold value.

In the following step 1400 the enhanced segmenting structures were expanded by an erosion process. Finally, the segmented and expanded areas were extrapolated by distance weighted gray-level values derived from surrounding pixel of the two-dimensional image in step 1500.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A method for removing high-contrast structures of line-shaped artificial objects with small width on a two-dimensional image (100, 500, 1000), the method comprising:
performing a low-pass filtering (1100) to the two-dimensional image using a filter width range (1110) corresponding to structures of a line-shaped artificial object to generate a low-pass filtered intensity image;
performing a multi-scale filter (1200) to the low-pass filtered intensity image for locating and enhancing the structure of the line-shaped artificial object to generate a multi-scale filtered intensity image.

2. The method according to claim 1, the method further comprising:
segmenting (1300) of enhanced structures located by the applied multi-scale filter with a threshold value.

3. The method according to claim 2, wherein the threshold value is predefined.

4. The method according to claim 2, wherein the threshold value is adaptive.

5. The method according to claim 1, the method further comprising:
expanding (1400) the enhanced segmenting structures by an erosion process.

6. The method according to claim 1, the method further comprising:
extrapolating (1500) the segmented and expanded areas by distance weighted gray-level values derived from surrounding pixel of the two-dimensional image.

7. The method according to claim 1, wherein the predefined scaling width (1210) and/or the filter width range (1110) is σ, with σₘᵢₙ≦σ≦σₘₐₓ, wherein σₘᵢₙ in has a size of one pixel and σₘₐₓ has a size of two pixel.

8. The method according to claim 1, wherein an algorithm of the multi-scale filter uses a Hessian matrix which is defined as
$$H ( σ , {p}_{x} , {p}_{y} ) = ( \begin{matrix}\frac{{\partial }^{2} {I}^{′} ( σ , {p}_{x} , {p}_{y} )}{\partial {p}_{x} \partial {p}_{x}} & \frac{{\partial }^{2} {I}^{′} ( σ , {p}_{x} , {p}_{y} )}{\partial {p}_{x} \partial {p}_{y}} \\ \frac{{\partial }^{2} {I}^{′} ( σ , {p}_{x} , {p}_{y} )}{\partial {p}_{y} \partial {p}_{x}} & \frac{{\partial }^{2} {I}^{′} ( σ , {p}_{x} , {p}_{y} )}{\partial {p}_{y} \partial {p}_{y}}\end{matrix} ) ,$$
where I′(σ, pₓ, p_{y}) is a low-pass filtered intensity projection I′ at an image position with pixel coordinates pₓ and p_{y} and with a predefined scale size σ.

9. The method according to claim 8, wherein the algorithm of the multi-scale filter is based on an analysis of eigenvalues λ₁ and λ₂ of the Hessian matrix H(σ, pₓ, p_{y}), the eigenvalues λ₁ and λ₂ are defined as
$${λ}_{\frac{1}{2}} ( σ , {p}_{x} , {p}_{y} ) = \frac{{I}_{xx} + {I}_{yy}}{2} \pm \sqrt{\frac{{( {I}_{xx} + {I}_{yy} )}^{2}}{4} + ( {I}_{xy} {I}_{yx} - {I}_{xx} {I}_{yy} )}$$
$$with$$
$${I}_{ij} = \frac{{\partial }^{2} {I}^{′} ( σ , {p}_{i} , {p}_{j} )}{\partial {p}_{i} \partial {p}_{j}} .$$

10. The method according to claim 9, the method further comprising:
defining for each pixel position pₓ and p_{y} a multi-scale filtered projection value R^{2D} with: R^{2D}(pₓ,p_{y})=max(σ^{3/2λ}₁(σ, pₓ, p_{y})|σₘᵢₙ≦σ≦σₘₐₓ),
applying the acquired multi-scale filtered projection value R^{2D} to the two-dimensional image.

11. The method according to claim 1, wherein the two-dimensional image is a projection image generated from rotational X-ray projection sequences

12. The method according to claim 1, wherein the line-shaped artificial objects is configured as one of the group consisting of a catheter, a wire guide tip, a stitch or a surgical tool.

13. The method according to claim 1, wherein predefined scaling widths are used (1210) in order to avoid the locating and enhancing of larger structures.

14. A system (900) for automated projection based removal of artificial high-contrast objects from a medical image, comprising:
a memory device for storing a program;
a processor in communication with the memory device, the processor operative with the program to:
performing a low-pass filtering (1100) to each pixel of the two-dimensional image in an intensity range of a structures of a line-shaped artificial object to generate a low-pass filtered intensity image;
performing a multi-scale filter (1200) to the low-pass filtered intensity image for locating and enhancing the structure of the line-shaped artificial objects to generate a multi-scale filtered intensity image; wherein a predefined scaling width is used in order to avoid the locating and enhancing of larger structures.

15. A computer program product comprising a computer useable medium having a computer program logic recorded thereon for removing artificial high-contrast objects from a medical image, the computer program logic comprising:
program code for performing a low-pass filtering to each pixel of the two-dimensional image in an intensity range of a structures of a line-shaped artificial object to generate a low-pass filtered intensity image;
program code for performing a multi-scale filter to the low-pass filtered intensity image for locating and enhancing the structure of the line-shaped artificial object to generate a multi-scale filtered intensity image; wherein a predefined scaling width is used in order to avoid the locating and enhancing of larger structures.
